(19) United States
(12) Patent Application Publication
(10) Pub. No.: US 2023/0021658 A1
(43) Pub. Date: Jan. 26, 2023

(54) TRAILER SYSTEMS

(71) Applicant: DBO Solutions, LLC, Arlington, WA (US)

(72) Inventor: William Benner, Arlington, WA (US)

(21) Appl. No.: 17/872,643

(22) Filed: Jul. 25, 2022

Related U.S. Application Data
(60) Provisional application No. 63/225,829, filed on Jul. 26, 2021.

(51) Int. Cl. B65F 3/20; B60P 3/22; B60P 1/00; B60P 1/16; B60P 1/58; B60G 17/017; B60G 17/015; B65F 3/26

(52) U.S. Cl. CPC B65F 3/201; B60P 3/22; B60P 1/006; B60P 1/162; B60P 1/58; B60G 17/017; B60G 17/0155; B65F 3/26; B60G 3/00

(57) ABSTRACT

A trailer system for hauling material. The trailer system including a frame and a container attached to the frame. A lid is operatively associated with a first aperture and adapted to at least move between an open position and a closed position. When in the closed position the lid seals the first aperture such that the seal is watertight. A gate is operatively associated with a second aperture and adapted to at least move between an open position and a closed position. When in the closed position the gate seals the second aperture such that the seal is watertight. A pusher plate assembly is arranged with the container for pushing material contained in the container in a direction towards the second aperture.

### CROSS REFERENCE TO RELATED APPLICATIONS

This application claims priority to U.S. Provisional Patent Application No. 63/225,829, filed Jul. 26, 2021, the entire contents of which are incorporated herein by reference.

### BACKGROUND

Vehicles with specialized trailers exist that are used for hauling many products including dirt, rock, liquid, waste (i.e., trash and other miscellaneous debris), etc. However, it seems there is a lack of adequate systems to transport dirt, rock, liquid, and waste. For example, tankers and dump trucks may be used, respectively, for disposal and hauling of liquid and solid waste. However, the tankers and/or dump trucks may not be suitable for hauling of the liquid and solid waste together because the liquid waste may not be sufficiently viscous to haul in a dump truck and/or the solid waste may be too viscous to haul in a tanker truck. Accordingly, there remains a need for trailer systems that are more suitable for hauling mixed waste.

### SUMMARY

Trailer systems for hauling waste (e.g., street waste debris, storm water, pond sludge, hydro excavation materials, drilling mud, carbon, sludges, sewer grease and grit, oil water separators debris, carwash debris, jet grout, etc.) are described herein. In one non-limiting example, the trailer system could be used in industrial construction applications and/or industrial maintenance applications for transporting liquid waste generated by an industrial vacuum truck. More specifically, this disclosure relates to trailer systems that have a container pivotably connected to a frame, that has a watertight lid and a watertight gate so that the container can be loaded from a top of the container and unloaded from a rear of the container. This summary is provided to introduce simplified concepts of trailer systems, which are further described below in the Detailed Description. This summary is not intended to identify essential features of the claimed subject matter, nor is it intended for use in determining the scope of the claimed subject matter.

For the purposes of this disclosure, in any instances where the phrase “operatively associated” is used, “operatively associated” could mean: “fastened,” “connected,” “coupled,” “attached,” etc. via mechanical fastening methods including welding, pivot joints, bolts, pin hinge mechanisms, etc.

In an embodiment, a trailer system includes a frame for coupling to a vehicle and pulling the trailer system. The trailer system includes a container attached to the frame. The container includes a first aperture arranged in a top surface of the container, and a lid assembly operatively associated with the first aperture and adapted to at least move between an open position and a closed position. When in the open position the lid is positioned a distance away from the first aperture such that a material is displaceable through the first aperture and into the container, and when in the closed position the lid seals the first aperture such that the seal is watertight.

The trailer system includes a second aperture arranged in a back wall of the container and a gate assembly operatively associated with the second aperture and adapted to at least move between an open position and a closed position. When in the open position the gate is positioned a distance away from the second aperture such that the material is displaceable through the second aperture and out of the container, and when in the closed position the gate seals the second aperture such that the seal is watertight. The trailer system may include a pusher plate assembly arranged with the container to displace the material contained in the container in a direction towards the second aperture and out through the second aperture. The trailer system may include an air suspension system operatively associated with the frame and adapted to at least move the frame between a raised position and a lowered position. When in the raised position the frame is positioned off a surface for pulling the trailer system, and when in the lowered position the frame is positioned on the surface for loading the container with the material.

The trailer system may include independently suspended wheels operatively associated with an air suspension system. The trailer system may include a ramp having a raised platform disposed a distance above the surface. The ramp providing for a truck (e.g., industrial vacuum truck) to park on the raised platform such that when the container attached to the frame is parked adjacent to the ramp the truck parked on the raised portion of the ramp is disposed above the first aperture arranged in the top surface of the container for unloading the material from the truck such that the material is displaced through the first aperture and into the container when the frame is in the lowered position.

Depending on the desired esthetic and mechanical properties of the trailer system, and a material that the trailer system is intended to carry, components may comprise metal, plastic, and/or ceramic.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example material disposal and hauling environment according to an embodiment in this disclosure.

FIG. 2 illustrates a perspective view of a trailer system that may be used in the material disposal hauling environment shown in FIG. 1 to haul material according to an embodiment in this disclosure.

FIG. 3 illustrates a perspective view of the trailer system of FIG. 2 in a transit mode according to an embodiment in this disclosure.

FIG. 4 illustrates a perspective view of the trailer system of FIG. 2 with a lid assembly in a closed position according to an embodiment in this disclosure.

FIG. 5 illustrates a perspective view of the trailer system of FIG. 2 with the lid assembly in an open position according to an embodiment in this disclosure.

FIG. 6 illustrates a perspective view of the trailer system of FIG. 2 in an unloading mode according to an embodiment in this disclosure.

FIG. 7 illustrates a side section view of another trailer system that may be used in the material disposal hauling environment shown in FIG. 1 to haul material according to an embodiment in this disclosure.

FIG. 8 illustrates a detail section view of a pusher plate assembly of the trailer system of FIG. 7 according to an embodiment in this disclosure.

FIG. 9 illustrates a side section view of the trailer system of FIG. 7 with the pusher plate assembly of trailer system in an extended position according to an embodiment in this disclosure.

FIG. 10 illustrates a side section view of the trailer system of FIG. 7 in an unloading mode and with the pusher plate assembly of trailer system in an extended position according to an embodiment in this disclosure.

### DETAILED DESCRIPTION

### Overview

This disclosure is directed to trailer systems having a container for transporting a material that has a watertight lid and a watertight gate so that the container can be loaded with the material from a top of the container and the material can be unloaded from a rear of the container. Because the trailer system has a container that has a watertight lid and a watertight gate, the trailer system may quickly and easily receive a load of a material. Moreover, because the trailer system has a watertight lid and a watertight gate, carbon emissions are reduced due to a reduced number of trips to a dump site is achieved as compared to tankers and/or dump trucks. Further, because the trailer system has a watertight lid and a watertight gate, the trailer system will keep equipment (e.g., vacuum trucks, street sweepers, etc.) at a jobsite and not on the road traveling hours to dump a load of debris.

### Illustrative Embodiments

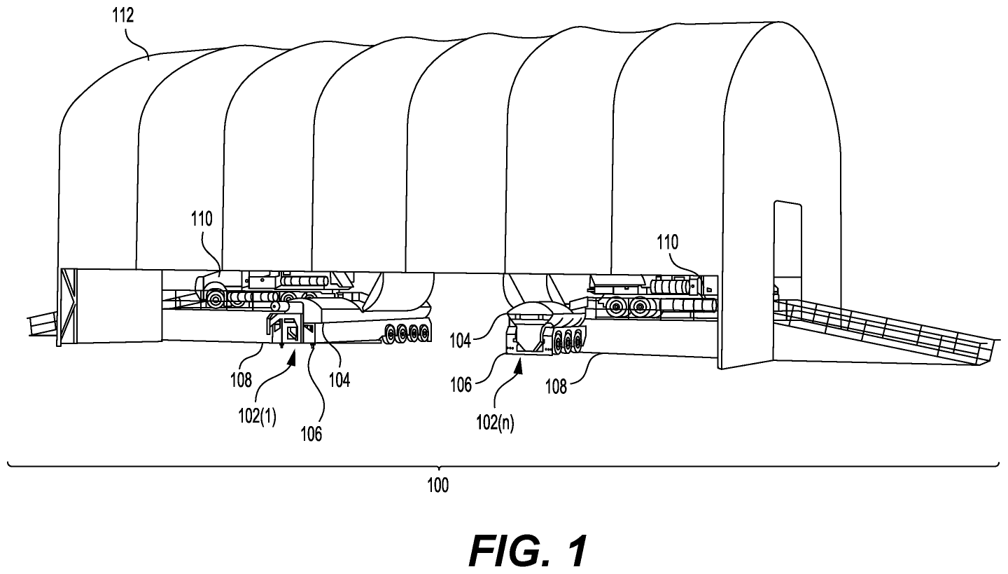

FIG. 1 illustrates an example material disposal and hauling environment 100 according to an embodiment in this disclosure. The material disposal and hauling environment 100 may include one or more trailer systems 102(1) and 102(n). The one or more trailer systems 102(1) and 102(n) include a container 104 attached to a frame 106. The one or more trailer systems 102(1) and 102(n) may include a ramp 108. The ramp 108 to provide for a truck 110 (e.g., industrial vacuum truck) to park on the raised platform. The truck 110 parked on the raised platform of the ramp 108 is capable of unloading a material (e.g., a liquid waste) from the truck 110 into the container 104. A building 112 may be arranged with the ramps 108 such that the building 112 provides shelter for the trucks 110 unloading the material into the container 104 of the one or more trailer systems 102(1) and 102(n).

The building 112 and ramps 108 may be arranged together at a site to define a satellite station that can be set up at a desired location to eliminate hours of unnecessary carbon emissions due to the trucks 110 having to transport the material to a remote dump site. For example, a satellite station including the building 112 and ramps 108 may be strategically located proximate to a job site such that the trailer systems 102(1) and 102(n) may be easily loaded with the material and more efficiently transport the material to a remote dump site as compared to of the trucks 110 transporting the material to the remote dump site. Because the one or more trailer systems 102(1) and 102(n) transport the material more efficiently than the trucks 110 to a remote dump site, the one or more trailer systems 102(1) and 102(n) reduce the carbon loading and greenhouse gases that the trucks 110 produce daily. With agencies looking to reduce their carbon footprint and be carbon neutral, these one or more trailer systems 102(1) and 102(n) are essential for meeting agencies needs to reduce their carbon footprint and be carbon neutral.

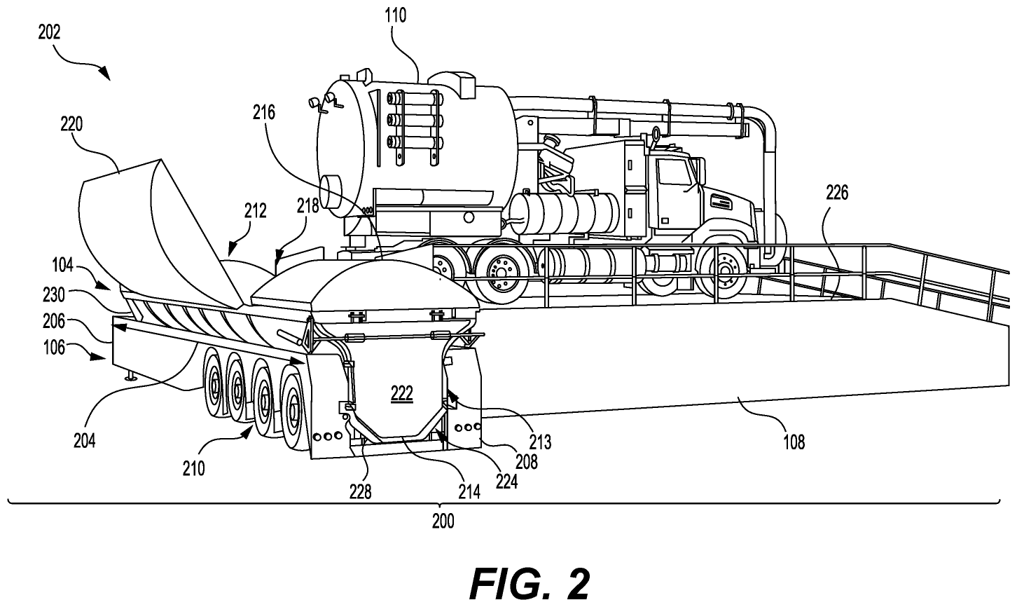

FIG. 2 illustrates a perspective view 200 of a trailer system 202 that may be used in the material disposal hauling environment 100 shown in FIG. 1 to haul material according to an embodiment in this disclosure. The trailer system 202 may be the same as the one or more trailer systems 102(1) and 102(n). The trailer system 202 can be set up at a desired location to eliminate hours of unnecessary carbon emissions due to the truck 110 having to transport the material to a remote dump site. The trailer system 202 may include the same elements and features as the one or more trailer systems 102(1) and 102(n). For example, the trailer system 202 may include the container 104 attached to the frame 106.

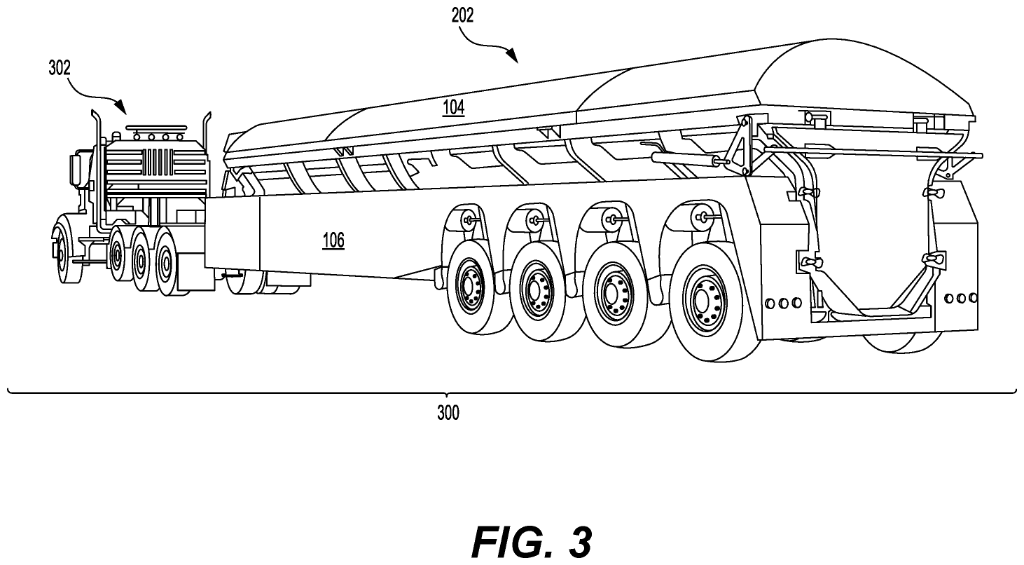

FIG. 2 illustrates the frame 106 extending a longitudinal length 204 between a front 206 of the frame 106 and a back 208 of the frame 106. The front 206 of the frame 106 including a coupling mechanism for coupling the frame 106 to a vehicle and the back 208 of the frame 106 including wheels 210 for pulling the trailer system 202. The wheels 210 of the frame 106 may each be independently suspended. An air suspension system may be further operatively associated (e.g., pivotably attached) with each of the independently suspended wheels 210 and the frame 106 and adapted to at least move the frame 106 between a raised position and a lowered position. For example, the frame 106 may include eight individually air suspended hubs that are pivotably attached to the frame and a user can operate to move the frame 106 between the raised position and the lowered position. When in the raised position the frame 106 is positioned off a surface for pulling the trailer system 202, and when in the lowered position the frame 106 is positioned on the surface for loading the container 104 with the material. FIG. 2 illustrates the frame 106 of the trailer system 202 in the lowered position where the frame 106 is positioned on the surface for loading the container 104 with the material. Because the frame 106 of the trailer system 202 is positioned on the surface, the trailer system 202 is firmly anchored on the surface for safely loading the container 104. Subsequent to being loaded with the material, the air suspension system may be operated to move the frame 106 off of the surface and into the raised position so that the trailer system 202 may be pulled to a remote dumpsite to unload the material from the container 104 (discussed in more detail below with regard to FIG. 3).

FIG. 2 illustrates the container 104 attached to the frame 106 extending the longitudinal length 204 between the front 206 of the frame 106 and the back 208 of the frame 106. The container 104 including a solid front wall 212 opposite a back wall 213, a solid bottom surface 214 opposite a top surface 216, a first aperture 218 arranged in the top surface 216, a lid 220 operatively associated (e.g., pivotably attached, slideably attached, removeably attached, etc.) with the first aperture 218 and adapted to at least move between an open position and a closed position. When in the open position, the lid 220 is positioned a distance away from the first aperture 218 such that the material is displaceable through the first aperture 218 and into the container 104. When in the closed position the lid 220 seals the first aperture 218 such that the seal is watertight. The lid 220 and/or the perimeter of the first aperture 218 may include a gasket to provide for sealing the lid 220 with the first aperture 218 when in the closed position. One or more hydraulic locks may be disposed with the lid 220 and the first aperture 218 to provide for locking the lid 220 in the closed position. Further, one or more manual latches (e.g., one or more DOT (Department of Transportation) latches) may be disposed with the lid 220 and the first aperture 218 to provide for additional protection to ensure the lid 220 remains secure in the closed position.

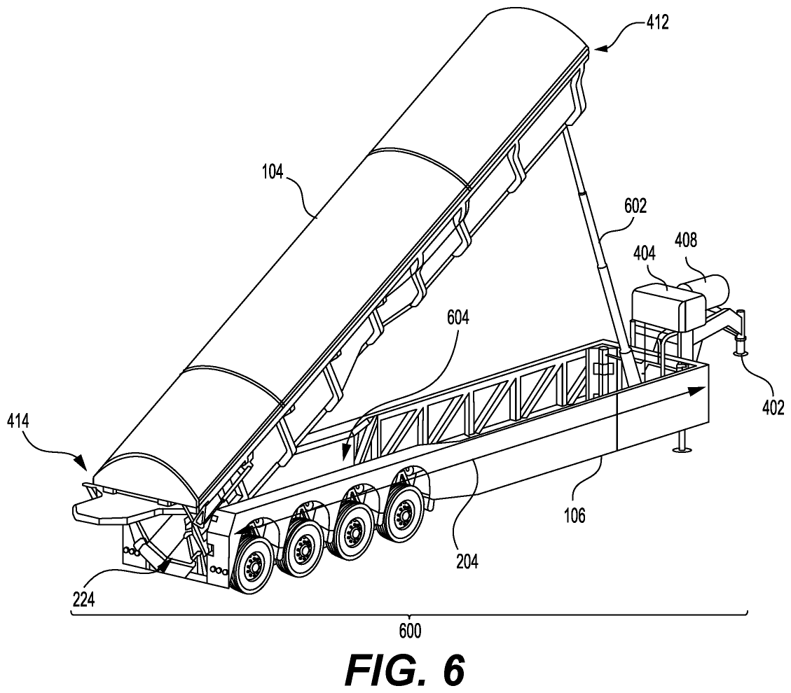

A gate 222 is operatively associated (e.g., pivotably attached, slideably attached, removeably attached, etc.) with a second aperture 224. The gate 222 adapted to at least move between an open position and a closed position. When in the open position the gate 222 is positioned a distance away from the second aperture 224 such that the material is displaceable through the second aperture 224 and out of the container 104 (described in more detail below with regard to FIG. 6). When in the closed position the gate 222 seals the second aperture 224 such that the seal is watertight. The gate 222 and/or the perimeter of the second aperture 224 may include a gasket to provide for sealing the gate 222 with the second aperture 224 when in the closed position. One or more hydraulic locks may be disposed with the gate 222 and the second aperture 224 to provide for locking the gate 222 in the closed position. Further, one or more manual latches (e.g., one or more DOT (Department of Transportation) latches) may be disposed with the gate 222 and the second aperture 224 to provide for additional protection to ensure the gate 222 remains secure in the closed position.

FIG. 2 illustrates the ramp 108 having a raised platform 226 disposed a distance above the surface. The ramp 108 provides for the truck 110 to park on the raised platform 226. When the container 104 attached to the frame 106 is parked adjacent to the ramp 108, the truck 110 parked on the raised platform 226 of the ramp 108 is disposed above the first aperture 218 arranged in the top surface 216 of the container 104 for unloading the material from the truck 110. The material unloaded from the truck 110 is displaced through the first aperture 218 and into the container 104 when the frame 106 is in the lowered position.

A back 228 of the container 104 may be pivotably attached proximate to the back 208 of the frame 106. A lifting system (described in more detail below with regard to FIG. 6) operatively associated (e.g., pivotably attached) with the container 104 is adapted to at least raise a front 230 of the container 104 opposite a back 228 of the container 104 to provide for displacing the material through the second aperture 224 and out of the container 104. The lifting system may include a hydraulic ram operatively associated (e.g., pivotably attached) with the front 230 of the container 104.

FIG. 3 illustrates a perspective view 300 of the trailer system 202 of FIG. 2 in a transit mode according to an embodiment in this disclosure. For example, subsequent to the truck 110 unloading the material into the container 104, the frame 106 may be raised off of the ground so that a semi-truck 302 may hook-up to the frame 106 and pull the trailer system 202 to a remote dump site to dispose of the material contained in the container 104. The semi-truck 302 may be a Class 8, 4-axel truck, with an industry standard 5^{th} wheel coupling, and a GVWR of about 105,000 lbs.

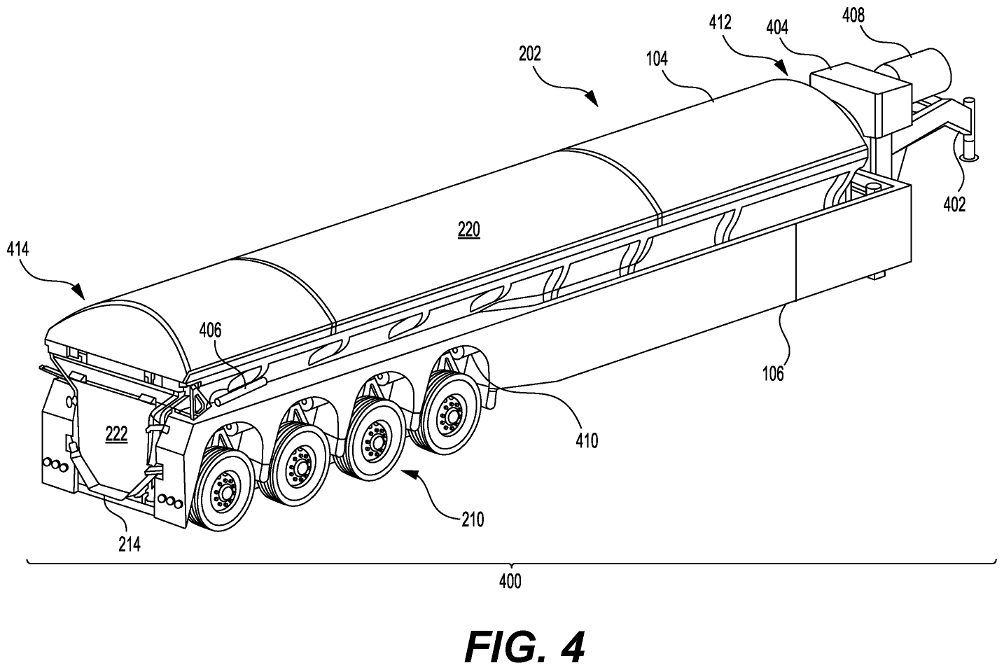

FIG. 4 illustrates a perspective view 400 of the trailer system 202 of FIG. 2 with the lid assembly 220 in a closed position according to an embodiment in this disclosure. FIG. 4 illustrates that the frame 106 includes a coupling mechanism 402 according to an embodiment in this disclosure . The coupling mechanism 402 may couple the frame 106 to a vehicle. For example, the coupling mechanism 402 may be a gooseneck hitch for hooking-up to the semi-truck 302.

The trailer system 202 may include a hydraulic system 404 arranged with the frame 106. For example, the trailer system 202 may include the hydraulic system 404 disposed on the coupling mechanism 402 of the frame 106. The hydraulic system 404 may be communicatively coupled with one or more hydraulic cylinders, latches, locks, rams, etc. For example, the hydraulic system 404 may be communicatively coupled with one or more hydraulic rams 406 (e.g., one or more trunnion mounted hydraulic rams) operatively associated (e.g., pivotably attached) with the gate 222 to displace the gate 222 between an open position and a closed position. The one or more hydraulic rams 406 may be attached to one or more mechanical linkage mechanisms (e.g., ternary linkage, coupler, binary coupler, binary coupler link, etc.) attached to a rod disposed proximate to the top portion of the gate 222. One or more hydraulic latches may be used to secure the gate 222 in the closed position. During operation, the one or more hydraulic latches are loosened while the one or more hydraulic rams 406 continue to hold the gate 222 in the closed position. As the container 104 is tilted in a vertical direction with respect to the ground plane, the one or more hydraulic rams 406 are displaced causing the one or more mechanical linkage mechanisms and/or the rod to be displaced to displace the gate 222 to the open position. A splash guard may be disposed with the gate 222 to direct a flow of waste from the container 104 in a controlled manner to avoid side splashing. In another example, the hydraulic system 404 may be communicatively coupled with one or more hydraulic rams (e.g., one or more enclosed hydraulic cylinders) operatively associated (e.g., pivotably attached) with the lid 220 to displace the lid 222 between an open position and a closed position. One or more hydraulic latches (e.g., one or more hydraulic hook latches) may be used to secure the lid 222 in the closed position. During the loading operation, an operator may unlock (e.g., disengaged) the one or more hydraulic latches. Subsequent to the one or more hydraulic latches being unlocked, an operator may actuate the one or more hydraulic rams to displace the lid 222 to the open position. Once loading of the container 104 is complete, the one or more hydraulic rams will displace the lid 222 to the closed position. An operator may lock the one or more hydraulic latches to complete the water-tight seal between the container 104 and the lid 222. The hydraulic system 404 may be communicatively coupled with a lifting system (discussed in more detail below with regard to FIG. 6). The lifting system operatively associated (e.g., pivotably attached) with the container 104 and adapted to at least raise a front 412 of the container 104 opposite a back 414 of the container 104 to provide for displacing the material through the second aperture and out of the container 104. The hydraulic system 404 may be communicatively coupled with a pusher plate assembly arranged with the container 104. For example, the hydraulic system 404 may be communicatively coupled with a pusher plate assembly arranged inside of the container 104. For example, the hydraulic system 404 may be communicatively coupled with a pusher plate assembly including a hydraulic ram and a plate attached to the hydraulic ram disposed inside of the container 104 for displacing the material contained in the container in a direction towards the second aperture 224 and out through the second aperture 224 of the container 104. A user may operate the hydraulic system 404 via of an operator station housing controls of the hydraulic system 404 on the driver side of the trailer system 202.

The trailer system 202 may include a pneumatic system 408 arranged with the frame 106. For example, the trailer system 202 may include the pneumatic system 408 disposed on the coupling mechanism 402 of the frame 106. The pneumatic system 408 may be communicatively coupled with an air suspension system 410 operatively associated (e.g., pivotably attached) with the frame 106 and adapted to at least move the frame 106 between a raised position and a lowered position. The pneumatic system 408 may be communicatively coupled with the air suspension system 410 and the air suspension system 410 may be further operatively associated (e.g., pivotably attached) with the independently suspended wheels 210. For example, the wheels 210 of the frame 106 may each be independently suspended, and the communicatively coupled pneumatic system 408 and air suspension system may be further operatively associated (e.g., pivotably attached) with each of the independently suspended wheels 210. The independently suspended wheels 210 operatively associated with the frame 106 and air suspension system 408 arranged to provide for the frame 106 to receive at least a lower portion of the container 104. For example, because the wheels 210 are independently suspended with the frame 106, an opening (e.g., a cradle, a channel, a gap, etc.) is defined that is arranged in the frame 106 along the longitudinal length 206 of the frame 106 between the driver side wheels 210 and passenger side wheels 210. The opening arranged in the frame 106 provides for the solid bottom surface 214 of the container 104 to be disposed down lower and closer to the surface (e.g., ground) than if the solid bottom surface 214 of the container 104 was disposed above the wheels 210. The opening may provide for the container 104 to be located below centerlines of axels of the wheels 210.

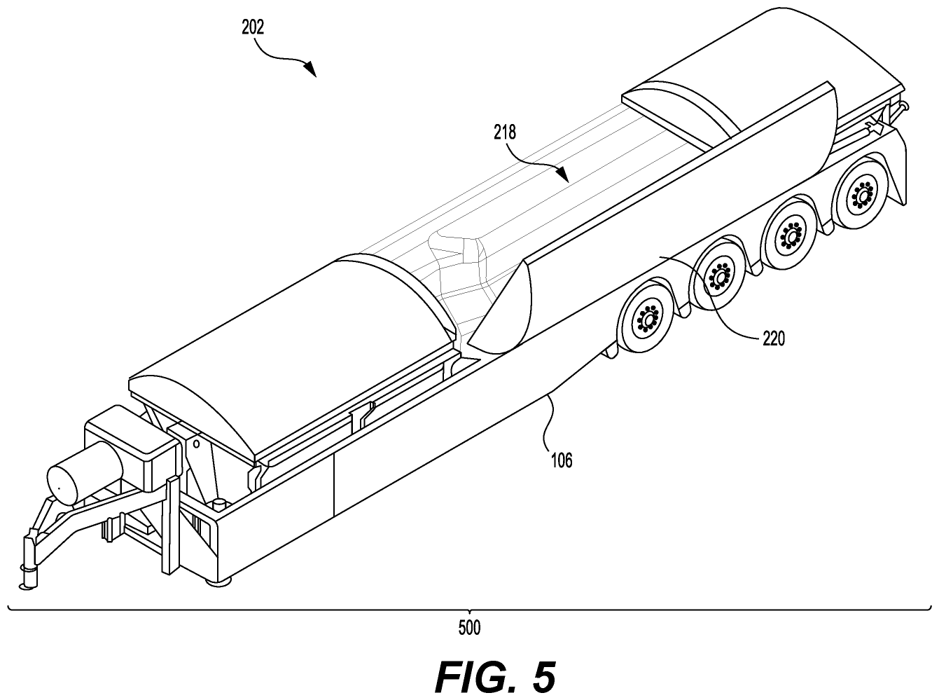

FIG. 5 illustrates a perspective view 500 of the trailer system 202 of FIG. 2 with the lid assembly 220 in an open position according to an embodiment in this disclosure. As discussed above, the lid 220 is operatively associated (e.g., pivotably attached) with the first aperture 218 and adapted to at least move between an open position and a closed position.

FIG. 6 illustrates a perspective view 600 of the trailer system of FIG. 2 in an unloading mode according to an embodiment in this disclosure. The hydraulic system 404 may be communicatively coupled with a lifting system 602. The lifting system 602 operatively associated (e.g., pivotably attached) with the container 104 and adapted to at least raise the front 412 of the container 104 opposite the back 414 of the container 104 to provide for displacing the material through the second aperture 224 and out of the container 104. The lifting system 602 may raise the front 412 of the container 104 by about 15 degrees for unloading the material out of the container 104 safely. For example, the lifting system 602 may raise the front 412 of the container 104 by about 15 degrees to reduce the probability of the trailer system 202 from tipping over as a result of the lifting system 602 raising the front 412 of the container 104 higher than about 15 degrees. Because the lifting system 602 raises the front 412 of the container 104 to about 15 degrees, the solid bottom surface 214 is positioned to have a non-zero slope to encourage the material contained in the container 104 to move toward the second aperture 224 and outside of the container 104. The lifting system 602 may comprise a hydraulic ram, hydraulic cylinder, a single hydraulic ram, multistage hydraulic ram, etc.

FIG. 6 illustrates an opening 604 arranged in the frame 106 along the longitudinal length 206 of the frame 106 between the driver side wheels 210 and passenger side wheels 210. As discussed above, the opening 604 arranged in the frame 106 provides for the solid bottom surface 214 of the container 104 to be disposed down lower and closer to the surface (e.g., ground).

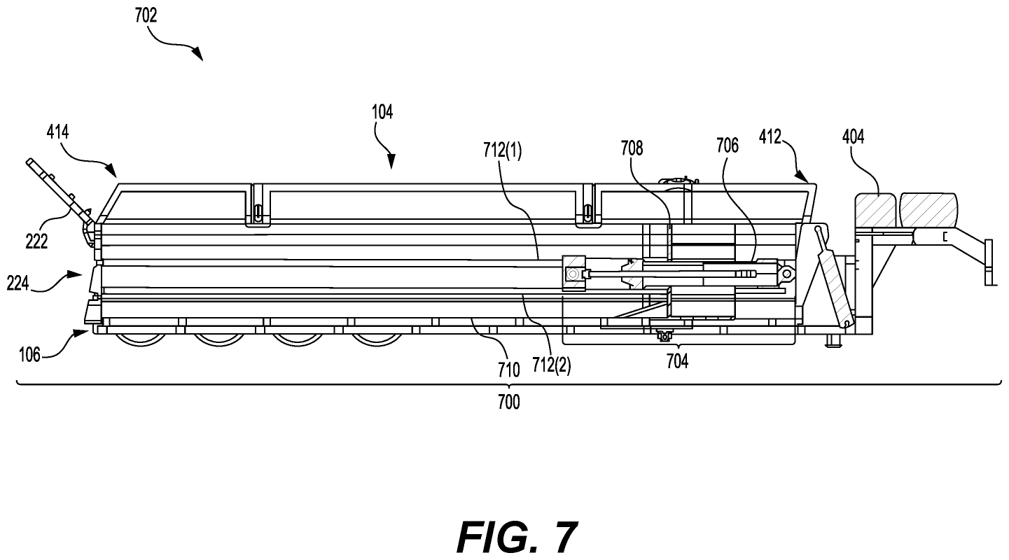

FIG. 7 illustrates a side section view 700 of a trailer system 702 that may be used in the material disposal hauling environment 100 shown in FIG. 1 to haul material according to an embodiment in this disclosure. The trailer system 702 may be the same as the trailer system(s) 102(1), and 102(n), and 202. The trailer system 702 can be set up at a desired location to eliminate hours of unnecessary carbon emissions due to the truck 110 having to transport the material to a remote dump site. The trailer system 702 may include the same elements and features as the trailer system(s) 102(1), and 102(n), and 202. For example, the trailer system 702 may include the container 104 attached to the frame 106.

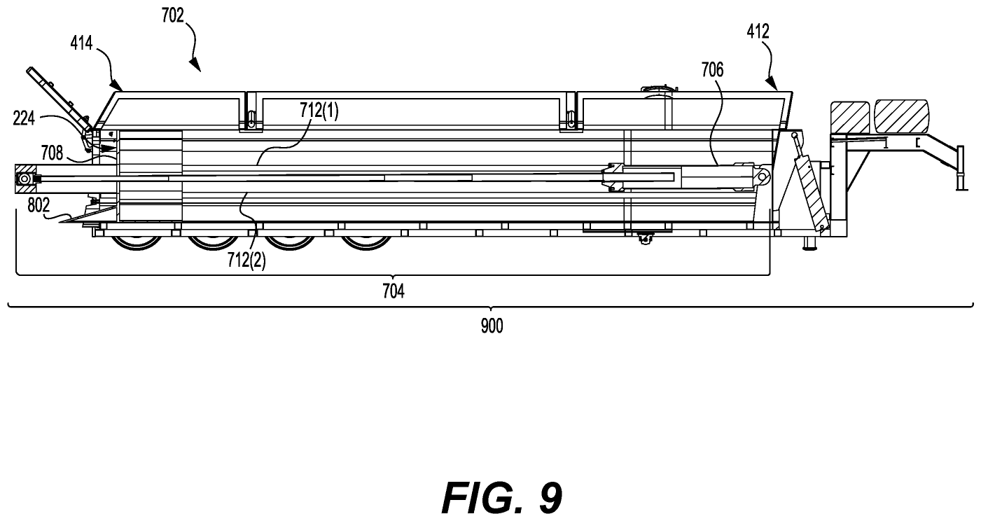

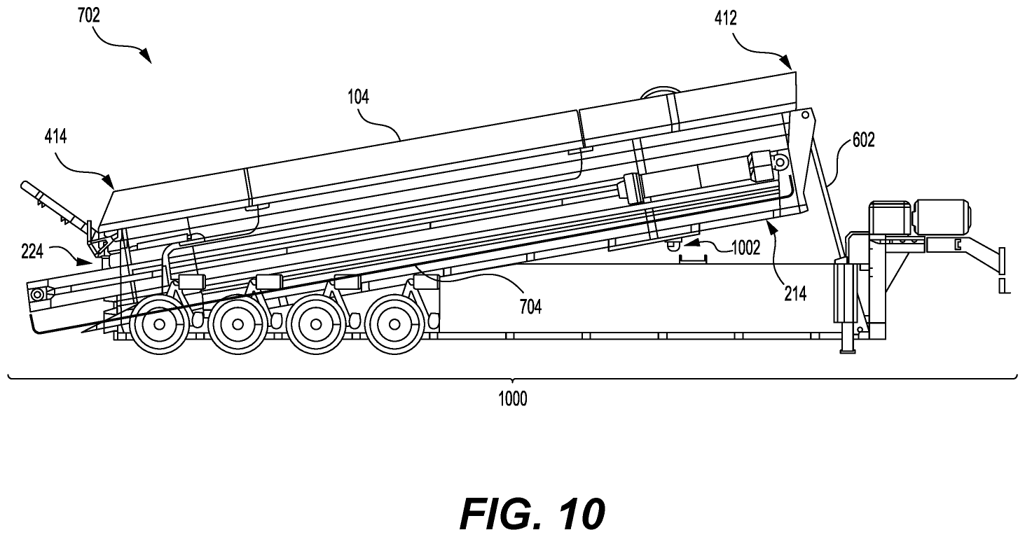

FIG. 7 illustrates a pusher plate assembly 704 arranged in the container 104 of the trailer system 702. As discussed above with regard to FIG. 4, the hydraulic system 404 may be communicatively coupled with the pusher plate assembly 704 arranged inside of the container 104. The pusher plate assembly 704 including a hydraulic ram 706 and a plate 708 attached to the hydraulic ram 706 disposed inside of the container 104 for displacing the material contained in the container in a direction towards the second aperture 224 and out through the second aperture 224 of the container 104. The plate 708 is arranged with the second aperture 224 and adapted to be displaced along a solid bottom surface 710 of the container 104. When the plate 708 is displaced along the solid bottom surface 710, the plate 708 displaces the material contained in the container 104 in a direction towards the second aperture 224 and out through the second aperture 224 (discussed in more detail below with regard to FIGS. 9 and 10). FIG. 7 illustrates pusher plate guide rails 712(1) and 712(2) may be arranged inside of the container 104 for guiding the plate 708 along a length of the container 104. FIG. 7 illustrates the pusher plate assembly 704 in a retracted position where the hydraulic ram 706 is retracted and the plate 708 attached to the hydraulic ram 706 is disposed in the container 104 proximate to the front 412 of the container 104.

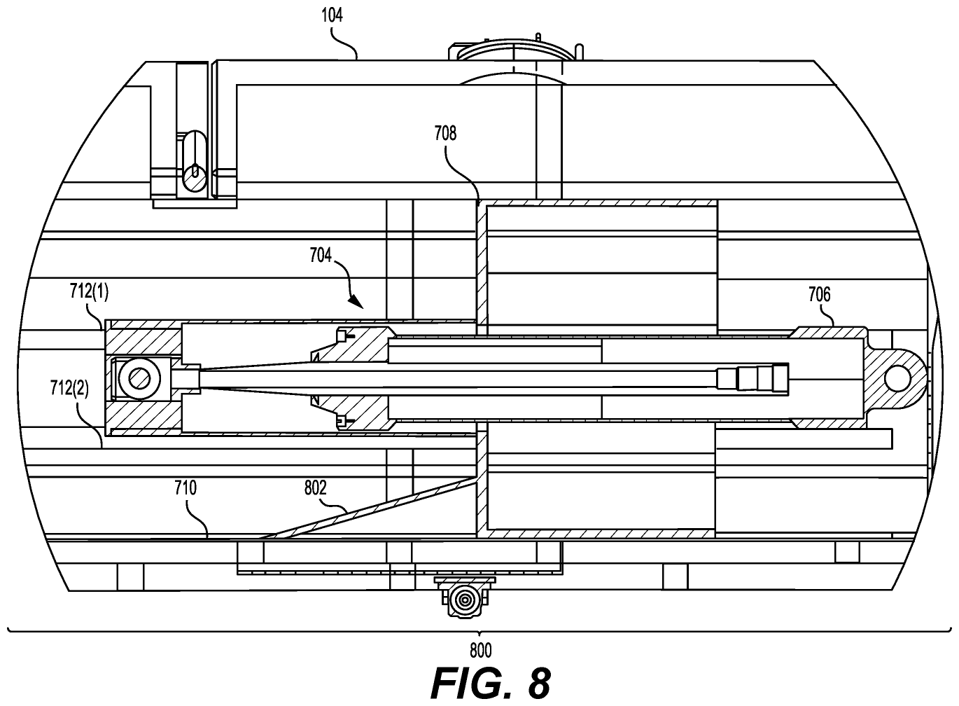

FIG. 8 illustrates a detail section view 800 of the pusher plate assembly 704 of the trailer system 702 of FIG. 7 according to an embodiment in this disclosure. The detail section view 800 of FIG. 8 illustrates the pusher plate assembly 704 including the plate 708 attached to the hydraulic ram 706 disposed inside of the container 104. The plate 708 may include a shovel plate portion 802 adapted to be displaced along the solid bottom surface 710 of the container 104. FIG. 8 illustrates the pusher plate guide rails 712(1) and 712(2) arranged with the plate 708 for guiding the plate 708 along a length of the container 104. When activated by a user, the hydraulic ram 706 may push the plate 708 along the inside of the container 104 with the shovel plate portion 802 extending past the second aperture 224 by a minimum distance of about 12 inches. The inside of the container 104 being smooth and uniform, providing for the hydraulic ram 706 to push the plate 708 unobstructed along the length of the container 104.

FIG. 9 illustrates a side view 900 of the trailer system 702 of FIG. 7 with the pusher plate assembly 704 of trailer system 702 in an extended position according to an embodiment in this disclosure. When in the extended position, the pusher plate assembly 704 is in an extended position where the hydraulic ram 706 is extended and the plate 708 attached to the hydraulic ram 706 is disposed in the container 104 proximate to the back 414 of the container 104. When the pusher plate assembly 704 is extended and/or retracted in the container 104, the pusher plate guide rails 712(1) and 712(2) arranged with the plate 708 guide the plate 708 along a length of the container 104. FIG. 9 illustrates that when the pusher plate assembly 704 is extended into the extended position, the shovel plate portion 802 of the plate 708 may extend out past the second aperture 224 to displace the material contained in the container 104 out through the second aperture 224.

FIG. 10 illustrates a side section view 1000 of the trailer system 702 of FIG. 7 in an unloading mode and with the pusher plate assembly 704 of trailer system 702 in the extended position according to an embodiment in this disclosure. As discussed above, the lifting system 602 is operatively associated (e.g., pivotably attached) with the container 104 and adapted to at least raise the front 412 of the container 104 opposite the back 414 of the container 104 to provide for displacing the material through the second aperture 224 and out of the container 104. FIG. 10 further illustrates one or more vibrators 1002 may be disposed with the container 104 and adapted to at least vibrate the container 104 to provide for displacing the material toward the second aperture 224. For example, the one or more vibrators may be attached to the solid bottom surface 214 of the container 104 and may be activated while the lifting system 602 raises the front 412 of the container 104 for breaking a static friction between the inside surface of the container 104 and the material to provide for encouraging the material to move toward the second aperture 224. The vibrator may be fastened (e.g., bolted) to one or more plates arranged along the solid bottom surface 214 of the container 104.

### Conclusion

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A trailer system for hauling material, the trailer system comprising:
a frame extending a longitudinal length between a front of the frame and a back of the frame, the front of the frame including a coupling mechanism for coupling the frame to a vehicle and the back of the frame including wheels for pulling the trailer system;
a container attached to the frame and extending the longitudinal length between the front of the frame and the back of the frame, the container for containing the material and including:
a solid front wall opposite a back wall;
a solid bottom surface opposite a top surface;
a first aperture arranged in the top surface;
a lid operatively associated with the first aperture and adapted to at least move between an open position and a closed position, wherein:
when in the open position the lid is positioned a distance away from the first aperture such that the material is displaceable through the first aperture and into the container, and
when in the closed position the lid seals the first aperture such that the seal is watertight;
a second aperture arranged in the back wall proximate to the solid bottom surface;
a gate operatively associated with the second aperture and adapted to at least move between an open position and a closed position, wherein:
when in the open position the gate is positioned a distance away from the second aperture such that the material is displaceable through the second aperture and out of the container, and
when in the closed position the gate seals the second aperture such that the seal is watertight; and
a pusher plate assembly arranged with the container, the pusher plate assembly including a plate operatively associated with the second aperture and adapted to be displaced along the solid bottom surface,
wherein when the plate is displaced along the solid bottom surface, the plate displaces the material contained in the container in a direction towards the second aperture and out through the second aperture.

2. The trailer system of claim 1, further comprising an air suspension system operatively associated with the frame and adapted to at least move the frame between a raised position and a lowered position, wherein:
when in the raised position the frame is positioned off a surface for pulling the trailer system, and
when in the lowered position the frame is positioned on the surface for loading the container with the material.

3. The trailer system of claim 2, wherein the wheels of the frame are each independently suspended, and the air suspension system is further operatively associated with each of the independently suspended wheels.

4. The trailer system of claim 2, further including a ramp having a raised platform disposed a distance above the surface, the ramp to provide for a truck to park on the raised platform such that when the container attached to the frame is parked adjacent to the ramp the truck parked on the raised portion of the ramp is disposed above the first aperture arranged in the top surface of the container for unloading the material from the truck such that the material is displaced through the first aperture and into the container when the frame is in the lowered position.

5. The trailer system of claim 1, wherein a back of the container is pivotably attached proximate to the back of the frame, and
wherein the trailer system further comprises a lifting system operatively associated with the container and adapted to at least raise a front of the container opposite a back of the container to provide for displacing the material through the second aperture and out of the container.

6. The trailer system of claim 5, wherein the lifting system includes a hydraulic ram operatively associated with the front of the container.

7. The trailer system of claim 1, further comprising one or more vibrators operatively associated with the container adapted to at least vibrate the container to provide for displacing the material toward the second aperture.

8. A trailer system for hauling material, the trailer system comprising:
a container pivotably attached to a frame, the container extending a longitudinal length between a front of the frame and a back of the frame, the container for containing the material and including:
a solid front wall opposite a back wall;
a solid bottom surface opposite a top surface;
a first aperture arranged in the top surface;
a lid assembly operatively associated with the first aperture and adapted to at least move between an open position and a closed position, wherein:
when in the open position the lid is positioned a distance away from the first aperture such that the material is displaceable through the first aperture and into the container, and
when in the closed position the lid seals the first aperture such that the seal is watertight; and
a pusher plate assembly arranged with the container, the pusher plate assembly including a plate operatively associated with a second aperture arranged in the back wall, the plate adapted to be displaced along the solid bottom surface,
wherein when the plate is displaced along the solid bottom surface, the plate displaces the material contained in the container in a direction towards the second aperture.

9. The trailer system of claim 8, further comprising an air suspension system operatively associated with the frame and adapted to at least move the frame between a raised position and a lowered position, wherein:
when in the raised position the frame is positioned off a surface for pulling the trailer system, and
when in the lowered position the frame is positioned on the surface for loading the container with the material.

10. The trailer system of claim 9, wherein the wheels of the frame are each independently suspended, and the air suspension system is further operatively associated with each of the independently suspended wheels.

11. The trailer system of claim 9, further including a ramp having a raised platform disposed a distance above the surface, the ramp to provide for a truck to park on the raised platform such that when the container attached to the frame is parked adjacent to the ramp the truck parked on the raised portion of the ramp is disposed above the first aperture arranged in the top surface of the container for unloading the material from the truck such that the material is displaced through the first aperture and into the container when the frame is in the lowered position.

12. The trailer system of claim 8, wherein a back of the container is pivotably attached proximate to the back of the frame, and
wherein the trailer system further comprises a lifting system operatively associated with the container and adapted to at least raise a front of the container opposite a back of the container to provide for displacing the material through the second aperture and out of the container.

13. The trailer system of claim 12, wherein the lifting system includes a hydraulic ram operatively associated with the front of the container.

14. The trailer system of claim 8, further comprising one or more vibrators operatively associated with the container adapted to at least vibrate the container to provide for displacing the material toward the second aperture.

15. A trailer system for hauling material, the trailer system comprising:
a container pivotably attached to a frame and extending a longitudinal length between a front of the frame and a back of the frame, the container for containing the material and including:
a solid front wall opposite a back wall;
a solid bottom surface opposite a top surface;
a first aperture arranged in the top surface for receiving the material;
a lid assembly sealing the first aperture such that the seal is watertight;
a second aperture arranged in the back wall proximate to the solid bottom surface;
a gate assembly operatively associated with the second aperture and adapted to at least move between an open position and a closed position, wherein:
when in the open position the gate is positioned a distance away from the second aperture such that the material is displaceable through the second aperture and out of the container, and
when in the closed position the gate seals the second aperture such that the seal is watertight; and
a pusher plate assembly arranged with the container, the pusher plate assembly including a plate operatively associated with the second aperture and adapted to be displaced along the solid bottom surface,
wherein when the plate is displaced along the solid bottom surface, the plate displaces the material contained in the container in a direction towards the second aperture and out through the second aperture.

16. The trailer system of claim 15, further comprising an air suspension system operatively associated with the frame and adapted to at least move the frame between a raised position and a lowered position, wherein:
when in the raised position the frame is positioned off a surface for pulling the trailer system, and
when in the lowered position the frame is positioned on the surface for loading the container with the material.

17. The trailer system of claim 16, wherein the wheels of the frame are each independently suspended, and the air suspension system is further operatively associated with each of the independently suspended wheels.

18. The trailer system of claim 16, further including a ramp having a raised platform disposed a distance above the surface, the ramp to provide for a truck to park on the raised platform such that when the container attached to the frame is parked adjacent to the ramp the truck parked on the raised portion of the ramp is disposed above the first aperture arranged in the top surface of the container for unloading the material from the truck such that the material is displaced through the first aperture and into the container when the frame is in the lowered position.

19. The trailer system of claim 15, wherein a back of the container is pivotably attached proximate to the back of the frame, and
wherein the trailer system further comprises a lifting system operatively associated with the container and is adapted to at least raise a front of the container opposite a back of the container to provide for displacing the material through the second aperture and out of the container.

20. The trailer system of claim 15, further comprising one or more vibrators operatively associated with the container adapted to at least vibrate the container to provide for displacing the material toward the second aperture.
